(19) United States
(12) Patent Application Publication
(10) Pub. No.: US 2023/0117312 A1
(43) Pub. Date: Apr. 20, 2023

(54) INTELLIGENT INTERACTIVE GAME SYSTEM AND VALUE-ADDING AND REDEMPTION METHOD THEREOF

(71) Applicant: POSLAB TECHNOLOGY CORPORATION, New Taipei City (TW)

(72) Inventors: REN-JYE CHANG, NEW TAIPEI CITY (TW); JY-NING CHANG, NEW TAIPEI CITY (TW); CHEN-YING HSU, NEW TAIPEI CITY (TW); JIUN-PIN JUNG, NEW TAIPEI CITY (TW)

(21) Appl. No.: 17/503,674

(22) Filed: Oct. 18, 2021

(51) Int. Cl. G07F 17/32; G06K 19/07

(52) U.S. Cl. CPC G07F 17/3251; G07F 17/3253; G07F 17/3211; G07F 17/3297; G06K 19/0723

(57) ABSTRACT

A smart interactive game system includes a host, a display module, an electronic ticket database, a contactless electronic ticket, and a communication module. The host displays an initial interface through the display module, then generates service information according to first choice information of the initial interface. Through the communication module, encryption information related to the contactless electronic ticket is sent to the electronic ticket database to generate electronic ticket information. A virtual and real integrated interface associated with the service information is displayed through the display module. The host generates value-adding and redemption information according to first manipulation of the virtual and real integrated interface, and updates the electronic ticket information and the encryption information according to the value-adding and redemption information. The present invention is compatible to game machines, and thus provides an automatic value-adding interactive game system, wherein values are added automatically as games are being played.

### 1. FIELD OF THE INVENTION

The present invention relates to an intelligent interactive game system, more particularly an intelligent interactive game system and a value-adding and redemption method thereof.

### 2. DESCRIPTION OF THE RELATED ART

In recent years, claw cranes, or claw machines, are becoming popular. Claw machines can often be seen near transport stations or on the streets. A conventional claw machine would passively wait for a player to insert coins. Once coins are inserted the claw machine allows the player to control a robotic crane to attempt snatching items stored within the claw machine. If the snatching attempt is successful, the snatched item would be displaced and dropped to a hole, where the player can take the item away as a prize. Further, some claw machines include a guarantee price. After the player has inserted enough coins with equivalent value of the guarantee price, the claw machine allows the player to continuously snatch for the item until a snatch attempt is successful.

However, a drawback of the conventional craw machine is that it requires the player to insert a great amount of coins. Despite positioning coin exchanging machines nearby to help players exchanging bills into coins, owners of the claw machine is nevertheless required to inspect and to replenish coins regularly for the coin exchanging machines. Unfortunately, the coin exchanging machines complementary to the clawing machines often become general coin exchangers for non-players. This results in great inconvenience for the owners of the coin exchanging machines.

Furthermore, a conventional arcade usually includes many different types of game machines. For most of the game machines, once the player earns certain amount of points in games, the game machine dispenses tokens correspondingly. The player would then hand over the tokens to a staff to manually count the amount of tokens earned. However, manually counting tokens is prone to miscalculations. Further, since most tokens lack any sort of identification mechanism, the tokens can be easily counterfeited. Since the staff cannot visibly spot out counterfeited tokens, this game and reward system is systematically flawed.

Regarding the two different game systems mentioned above, both have systematic issues that need to be solved.

### SUMMARY OF THE INVENTION

A main goal of the present invention is to provide an intelligent interactive game system, wherein the present invention uses a contactless electronic ticket and an electronic ticket database to simultaneously store encryption information and electronic ticket information. A virtual and real integrated interface generates first manipulation information, and according to the first manipulation information, points information inside of a game machine is accordingly increased or decreased. This method replaces the conventional method of inserting coins for controlling game machines in an arcade. A player would be able to fully control game machines with the electronic ticket information stored on the contactless electronic ticket. The present invention also provides a fast and easy way for value-adding online. The present invention is both safe and compatible to various game machines.

Another goal of the present invention is to provide an intelligent interactive game system, wherein the present invention displays a virtual and real integrated interface through a display module. Simultaneously, the display module also displays a virtual and real integrated game interface. The virtual and real integrated game interface is related to game execution information, and the game execution information is related to second manipulation information generated through the virtual and real integrated game interface. According to the first manipulation of the virtual and real integrated interface and the second manipulation information of the virtual and real integrated game interface, the present invention generates value-adding and redemption information. As a result, the present invention provides an automatic value-adding interactive game system, wherein values are added automatically as games are being played. The present invention is entertaining for players, and is also compatible to various game machines.

Another goal of the present invention is to provide an intelligent interactive game system, wherein the present invention includes a contactless electronic ticket and an electronic ticket database. The contactless electronic ticket includes encryption information, and the electronic ticket database stores multiple pieces of electronic ticket information relating to the contactless electronic ticket. A host creates value-adding and redemption information according to first manipulation information of a virtual and real integrated interface. The host then updates the electronic ticket information and the encryption information according to the value-adding and redemption information. This way the present invention provides a highly secure environment for trading exchanges. By having double verification of the electronic ticket information and the encryption information for the contactless electronic ticket and the host, the present invention is both convenient and safe.

To accomplish the goals above, the present invention provides a value adding and redemption method, including:

a choosing step: displaying an initial interface through the display module, and generating service information according to first choice information of the initial interface through a host;

a sending step: sending encryption information and electronic ticket information to an electronic ticket database through a communication module connected to the host; wherein the encryption information and the electronic ticket information are related to a contactless electronic ticket;

a matching step: confirming whether the encryption information and the electronic ticket information are identical to information stored in the electronic ticket database through the electronic ticket database;

a displaying step: displaying the electronic ticket information and a virtual and real integrated interface relating to the service information simultaneously through the display module; wherein the virtual and real integrated interface allows a player to manipulate.

The value-adding and redemption method further includes:

a value-adding and redemption step: generating value-adding and redemption information according to first manipulation information of the virtual and real integrated interface through the host, and sending the value-adding and redemption information to the electronic ticket database through the communication module; and

an updating step: updating the electronic ticket information according to the value-adding and redemption information through the electronic ticket database.

The value-adding and redemption method further includes:

a returning step: returning the updated electronic ticket information to the host through the electronic ticket database, and displaying the updated electronic ticket information through the display module.

The value-adding and redemption method further includes:

a sensing step: sensing the encryption information and the electronic ticket information stored in the contactless electronic ticket through a sensing module connected to the host, and displaying a sensing interface through the display module; wherein, the contactless electronic ticket uses a radio-frequency identification (RFID) method to generate the encryption information.

The value-adding and redemption method further includes:

an abnormality displaying step: displaying an abnormal interface through the display module when any one of the steps of the value-adding and redemption method shows abnormalities.

The value-adding and redemption method further includes:

a game choosing step: displaying a game choosing interface through the display module, and creating game execution information according to second choice information of the game choosing interface through the host; and

a gaming step: displaying a virtual and real integrated game interface relating to the game execution information through the display module; wherein the virtual and real integrated game interface is provided for player manipulations; and wherein, for the value-adding and redemption step, the value-adding and redemption information is further generated according to the first manipulation information of the virtual and real integrated interface and second manipulation information of the virtual and real integrated game interface through the host.

The value-adding and redemption method further includes:

a raffling step: generating raffle information according to third choose information of a raffle choosing interface through the host; wherein for the sending step, the raffle information is further sent to the electronic ticket database through the communication module.

The value-adding and redemption method further includes:

redemption providing step: controlling an redemption counter according to redemption choosing information through the host; wherein the redemption counter further provides an redemption item corresponding to the redemption choosing information; and wherein the virtual and real integrated interface further comprises a redemption choosing window, and the redemption choosing information is generated according to the first manipulation information of the virtual and real integrated interface through the host.

To accomplish the goals above, based on the aforementioned value-adding and redemption method, the present invention also provides an intelligent interactive game system to execute the aforementioned value-adding and redemption method. The intelligent interactive game system includes:

a host;

a display module, coupled to the host; wherein the display module displays an initial interface, and the host creates service information according to the initial interface;

a contactless electronic ticket, connected to the host; wherein the contactless electronic ticket stores encryption information and electronic ticket information; and wherein the encryption information and the electronic ticket information are related to the contactless electronic ticket;

an electronic ticket database, installed in a cloud server to connect to the host, wherein the electronic ticket database also stores the encryption information and the electronic ticket information;

a communication module, coupled to the host, allowing real-time bi-directional data transfers between the host and the electronic ticket database; wherein when first choice information is generated through the initial interface, the display module further displays a virtual and real integrated interface related to the service information; and wherein the virtual and real integrated interface generates first manipulation information.

In the intelligent interactive game system, the host creates value-adding and redemption information according to the first manipulation information of the virtual and real integrated interface.

In the intelligent interactive game system, the electronic ticket database updates the electronic ticket information according to the value-adding and redemption information.

The intelligent interactive game system, further includes

a sensing module, coupled to the host, sensing the encryption information and the electronic ticket information stored in the contactless electronic ticket; wherein the contactless electronic ticket uses a radio-frequency identification (RFID) method to generate the encryption information.

The intelligent interactive game system further includes:

a redemption counter, coupled to the host; wherein the redemption counter includes multiple redemption items, and each of the redemption items corresponds to at least one piece of redemption choosing information.

As such, the intelligent interactive game system of the present invention is able to bi-directionally verify the electronic ticket information and the encryption information through the contactless electronic ticket and the host. This provides convenience and safety for the intelligent interactive game system. Furthermore, the present invention allows values adding through playing games, thus providing an automatic value-adding interactive game system. The present invention is entertaining for players, and is also compatible to game machines.

For people skilled in the related field to fully understand goals, features, and effects of the present invention, the following embodiments and their corresponding figures are used for detail explanations.

### BRIEF DESCRIPTION OF THE DRAWINGS

FIG. 1 is a perspective view of an intelligent interactive game system of the present invention.

FIG. 2 is a block diagram for steps of a value-adding and redemption method of the present invention.

FIG. 3 is a flow chart for executing steps of the value-adding and redemption method of the present invention.

FIG. 4 is a perspective view of a first embodiment of the intelligent interactive game system of the present invention.

FIG. 5 is a flow chart for executing steps of a first embodiment of the value-adding and redemption method of the present invention.

FIG. 6A is a block diagram for buying a card in the first embodiment of the value-adding and redemption method of the present invention.

FIG. 6B is a flow chart for buying a card in the first embodiment of the value-adding and redemption method of the present invention.

FIG. 7A is a block diagram for value-adding in the first embodiment of the value-adding and redemption method of the present invention.

FIG. 7B is a flow chart for value-adding in the first embodiment of the value-adding and redemption method of the present invention.

FIG. 8A is a block diagram for executing search in the first embodiment of the value-adding and redemption method of the present invention.

FIG. 8B is a flow chart for executing search in the first embodiment of the value-adding and redemption method of the present invention.

FIG. 9A is a block diagram for running games in the first embodiment of the value-adding and redemption method of the present invention.

FIG. 9B is a flow chart for running games in the first embodiment of the value-adding and redemption method of the present invention.

FIG. 10A is a block diagram for raffling in the first embodiment of the value-adding and redemption method of the present invention.

FIG. 10B is a flow chart for raffling in the first embodiment of the value-adding and redemption method of the present invention.

FIG. 11 is a perspective view of a second embodiment of the intelligent interactive game system of the present invention.

FIG. 12A is a block diagram for executing redemption in the second embodiment of the value-adding and redemption method of the present invention.

FIG. 12B is a flow chart for executing redemption in the second embodiment of the value-adding and redemption method of the present invention.

### DETAILED DESCRIPTION OF THE INVENTION

With reference to all figures detailing embodiments of the present invention, the following figures are able to more clearly articulate the present invention. Please be aware, the present invention is applicable to other forms of embodiment. The provided embodiments of the present invention are just a few examples used to convey concepts of the present invention to personnel in related fields. The figures are enlarged for better clarity detailing embodiments of the present invention.

The jargons used here are aimed to articulate specific embodiments of the present invention, rather than to be used as limitations to the present invention. Unless specifically mentioned, “a” and “the” used here may refer to terms in plural forms. Here “and/or” may refer to one or multiple combinations of terms. When a component “is connected” or “is coupled” to another component, the described components may directly connect or couple with each other, or may indirectly connect or couple with each other with other components in between.

Similarly, when a component, such as a layer, a section, or a base, is positioned “on” another component, the described component may directly be positioned on the other component, or may indirectly be positioned on the other component with other components in between. In relative terms, “directly” means without other components in between. When “include” or “consist” is used, features, units, steps, manipulations, components, modules, and/or subsets are conveyed to exist, though without excluding one or more existence or additions of other features, units, steps, manipulations, components, modules, and/or subsets.

Additionally, cross-sectional figures can be used to convey inventive ideas in embodiments of the present invention. Within allowed margins of a manufacturing method, figures may change shapes for demonstration purposes. For this reason, the figures of the present invention are not limited to their respective shapes, but are free to be other shapes according to different manufacturing methods. Areas in the figures are used to demonstrate shapes of components, rather than limitations to inventive concepts of the present invention.

Here “first”, “second”, and “third” may be used to describe and differentiate between different components, rather than limitations toward those components. For this reason, when a first component in an embodiment is being called a second component in another embodiment, the component still supports contents of the present invention. Embodiments used to demonstrate concepts of the present invention include relative items in support to the present invention. Here same reference number or same item represents the same component.

Furthermore, cross-sectional views and/or side views are for demonstrating concepts of embodiments of the present invention. Therefore, please expect manufacturing deviations from relative shapes of the components depicted in the figures. Embodiments are free to have other shapes than described here, as the figures here are for demonstration purposes only, rather than detailing realistic shapes of components.

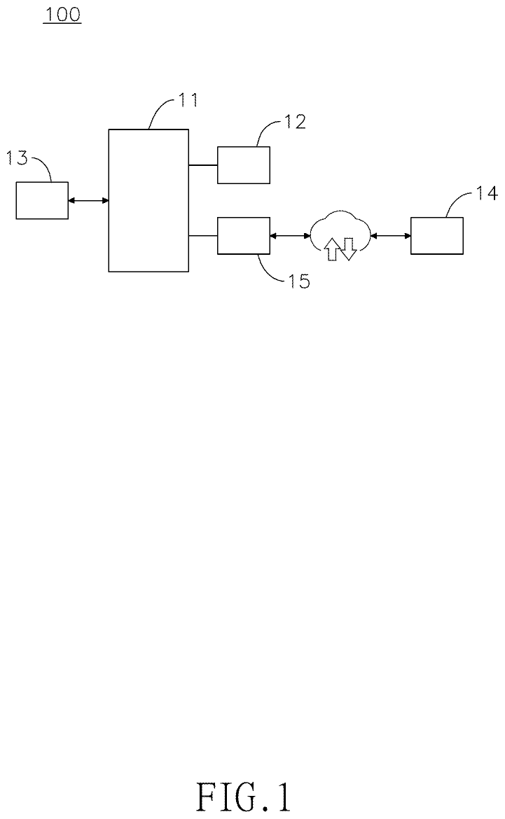

With reference to FIG. 1, a perspective view of an intelligent interactive game system 100 of the present invention is shown. The intelligent interactive game system 100 includes a host 11, a display module 12, a contactless electronic ticket 13, an electronic ticket database 14, and a communication module 15.

More particularly, the intelligent interactive game system 100 can be installed in a conventional arcade room without maintainers. The intelligent interactive game system 100 can use an Internet of Things (IoT) system to connect to various game machines in the arcade room for transferring points. For example, an IoT sensor can be installed for a claw machine in the arcade, so that points or values purchased through the intelligent interactive game system 100 by a player can be used on already existing game machines in the arcade, including the claw machine. For this reason, the intelligent interactive game system 100 is widely compatible to different game machines and accessible for the player. The present invention is free to be applied to other game machines.

More particularly, the host 11 is electrically connected to the display module 12. The host 11 includes a combination of software, hardware, an firmware. The host 11 can store a default game inside. The host 11 provides and executes game physics, game graphics, and other game related light and sound effects for the default game. Furthermore, through the display module 12, the host 11 is able to display a virtual and real integrated interface for the player. As the player performs manipulations through the virtual and real integrated interface, the virtual and real integrated interface accordingly generates first manipulation information. The virtual and real integrated interface includes a game screen and allows at least one way of player manipulation. The at least one way of player manipulation can be, for instance, allowing the player to click on a specific area on the display module 12, and allowing the player to follow through actions matching the game screen displayed, thus allowing the player to play the default game and earn value-adding prizes. The value-adding prizes can be used on game machines already existing in the arcade room. For this reason, the intelligent interactive game system 100 is widely compatible to game machines and highly entertaining for the player.

The display module 12 is coupled to the host 11. The display module 12 can be either a light-emitting diode (LED) display, an organic LED (OLED) display, or a quantum dot LED (QLED) display, and is also free to be other types of displays. In some embodiments, the display module 12 displays an initial interface. As the player makes a choice through the initial interface, the initial interface accordingly generates a first choice information. According to the first choice information of the initial interface, the host 11 generates service information. The display module 12 then correspondingly creates the virtual and real integrated interface according to the service information, for facilitating interactions between the player and the intelligent interactive game system 100, and for hosting the player manipulations.

In the present invention, the player manipulations of the virtual and real integrated interface includes paying various fees according to the service information created by the choice the player made through the initial interface. For instance, the player manipulations can include: inserting coins, inserting cash bills, engaging in electronic payments (with a credit card, or an easy card with money deposits), and engaging in mobile phone payments. The player manipulations related to paying money is free to include other payment methods.

The contactless electronic ticket 13 is connected to the host 11. The contactless electronic ticket 13 stores encryption information and electronic ticket information. In some embodiments, the contactless electronic ticket 13 uses a radio-frequency identification (RFID) method to create the encryption information. The encryption information, for example, includes a card serial number, a card holder's name, and an authorization, etc. The encryption information increases protection against hacking by lengthening a decryption key complementary to the encryption information. For example, in some embodiments, the encryption information is divided into 16 segments. Each segments can provide usage for multiple application systems, and each segment includes four blocks, wherein each block includes 16 bytes. The contactless information is free to include other forms of embodiments.

The electronic ticket information stored by the contactless electronic ticket 13 includes trading records, corresponding balance, points records, etc., as a receipt for value-adding. The electronic ticket information is free to include other things in another embodiment.

The contactless electronic ticket 13 can use a near-field communication (NFC) method, enabling communications between the contactless electronic ticket 13 and other devices within a few centimeters. The contactless electronic ticket 13 can also be an integrated circuit (IC) card using the RFID method, for instance, a credit card, an IPASS, an authorization card, a transport ticket, access ticket, etc. The contactless electronic ticket 13 can also be an electronic device using a Bluetooth wireless method for communication, for instance, a smart phone and a pad. The contactless electronic ticket 13 is free to be other forms in another embodiment of the present invention.

The electronic ticket database 14 is installed in a cloud server. The electronic ticket database 14 is connected to the host 11, and the electronic ticket database 14 also stores the electronic ticket information as the receipt for value-adding. The electronic ticket information is related to the contactless electronic ticket 13. In some embodiments, the electronic ticket database 14 may be a computer or a server used for verifying the contactless electronic ticket 13. The contactless electronic ticket 13 is also able to perform identity verification for the host, by bi-directionally verifying both the host 11 and the contactless electronic ticket 13. For example, the encryption information may include a set of random numbers generated by the contactless electronic ticket 13 and another set of random numbers generated by the host 11. The host 11 and the contactless electronic ticket 13 will simultaneously verify each other, making sure each other is legitimate. By bi-directionally verifying both the host 11 and the contactless electronic ticket 13, the intelligent interactive game system 100 is both convenient and safe to be used.

When any of the aforementioned data or verification is abnormal, for example, when the corresponding balance is off, the contactless electronic ticket 13 is irresponsive, the trading record is unusual, then the intelligent interactive game system 100 will determine an abnormality has occurred, and correspondingly display an abnormal interface through the display module 12. In the present invention, “abnormality” encompasses both electronic abnormalities and physical abnormalities. The definition and determination of abnormality is free to be otherwise in another embodiment of the present invention.

The communication module 15 is coupled to the host 11. The communication module 15 is used to facilitate bi-directional verification for the host 11 and the electronic ticket database 14. The communication module 15 can use wireless signals for data transfers, and the communication module 15 can utilize either the RFID method, the NFC method, the Bluetooth method, a third generation (3G) mobile network method, a fourth generation (4G) mobile network method, a Wi-Fi method, a wireless local area network (WLAN) method, or a fifth generation (5G) mobile network method for communication. The communication module 15 also can use wired signals for data transfers, such as an Ethernet method of communication. The communication module 15 can either send the encryption information to the electronic ticket database 14, or the communication module 15 can communicate with external devices, such as a personal laptop, a smart phone, or a pad, for data transfers. The communication module 15 is free to be elsewise in another embodiment of the present invention.

The external devices are able to communicate with the host 11 through the communication module 15 for adjusting settings for the intelligent interactive game system 100. If other methods can be used to adjust the intelligent interactive game system 100 of the present invention, and to send the encryption information to the electronic ticket database 14, then the communication module 15 may also be any other equipment that allows for di-directional communications with the electronic ticket database 14. However, in order to minimize space required for installing the intelligent interactive game system 100, in a better embodiment, the intelligent interactive game system 100 communicates with external devices through the communication module 15. Communication between the host 11 and external devices is free to be elsewise in another embodiment of the present invention.

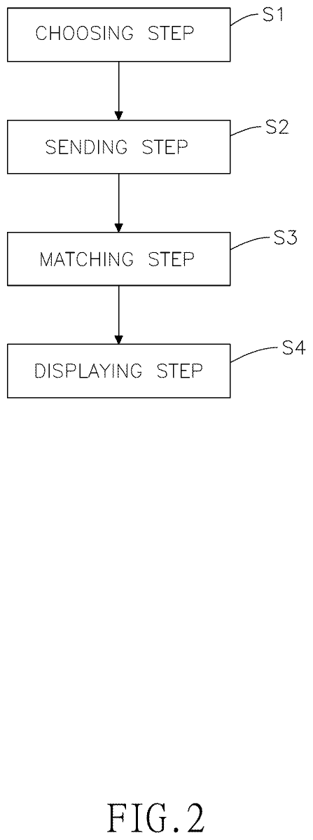

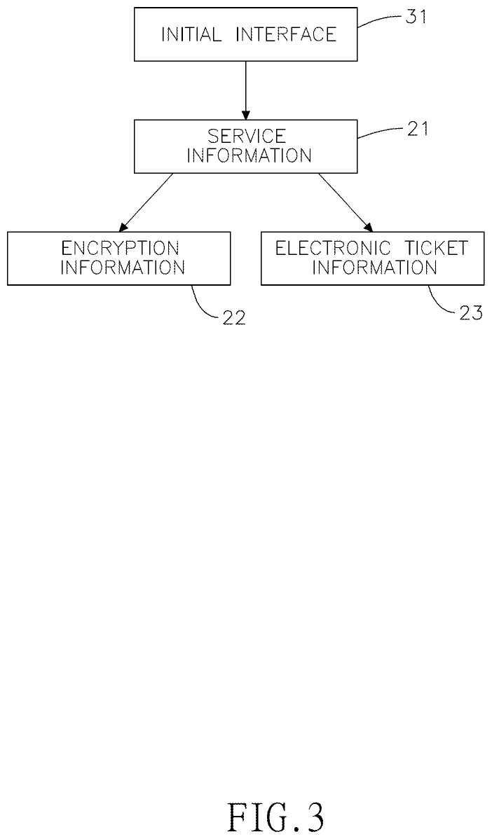

With reference to FIGS. 2 and 3, FIG. 2 details a block diagram for steps of a value-adding and redemption method of the present invention, and FIG. 3 details a flow chart for executing steps of the value-adding and redemption method of the present invention. Based on the intelligent interactive game system 100, the present invention further provides a value-adding and redemption method for executing the intelligent interactive game system 100, The value-adding, and redemption method includes the following steps:

A choosing step S1: displaying an initial interface 31 through the display module 12, and generating a service information 21 according to first choice information of the initial interface 31.

A sending step S2: sending encryption information 22 and electronic ticket information 23 to an electronic ticket database 14 through a communication module 15 connected to the host 11; wherein the encryption information 22 and the electronic ticket information 23 are related to a contactless electronic ticket 13.

A matching step S3: confirming whether the encryption information 22 and the electronic ticket information 23 are identical to information stored in the electronic ticket database 14 through the electronic ticket database 14.

A displaying step S4: displaying the electronic ticket information 23 and a virtual and real integrated interface 32 relating to the service information 21 simultaneously through the display module 12.

As described above, the contactless electronic ticket 13 and the electronic ticket database 14 simultaneously store the encryption information 22 and the electronic ticket information 23, to replace a conventional method of inserting coins for controlling game machines in an arcade. A player would be able to fully control game machines with the electronic ticket information 23 stored in the contactless electronic ticket 13. The present invention provides for a fast and easy way for value-adding online. The present invention is both safe and widely compatible to different game machines.

In some embodiments, the value-adding and redemption method further includes:

A value-adding and redemption step S5: generating value-adding and redemption information 24 according to first manipulation information of the virtual and real integrated interface 32 through the host 11, and sending the value-adding and redemption information 24 to the electronic ticket database 14 through the communication module 15.

An updating step S6: updating the electronic ticket information 23 according to the value-adding and redemption information 24 through the electronic ticket database 14.

A returning step: returning the updated electronic, ticket information 23 to the host 11 through the electronic ticket database 14, and displaying the updated electronic ticket information 23 through the display module 12.

A sensing step: sensing the encryption information 22 and the electronic ticket information 23 stored in the contactless electronic ticket 13 through a sensing module connected to the host 11.

A redemption providing step: controlling a redemption counter according to redemption choosing information through the host 11; wherein the redemption counter further provides a redemption item corresponding to the redemption choosing information.

A game choosing step: displaying a game choosing interface through the display module 12, and creating game execution information according to second choice information of the game choosing interface through the host 11.

A gaming step: displaying a virtual and real integrated game interface relating to the game execution information through the display module 12; wherein, for the value-adding and redemption step S5, the value adding and redemption information 24 is further generated according to the first manipulation information of the virtual and real integrated interface 32 and second manipulation information of the virtual and real integrated game interface through the host 11.

A raffling step: generating raffle information according to third choice information of a raffle choosing interface 12; wherein for the sending step S2, the raffle information is further sent to the electronic ticket database 14 through the communication module 15.

An abnormality displaying step: displaying an abnormal interface through the display module 12 when any step of the value-kidding and redemption method shows abnormalities.

The aforementioned second choice information is generated by the game choosing interface according to a game selecting choice made by the player through the game choosing interface. The second manipulation information is generated by the virtual and real integrated game interface according to manipulations and interactions made by the player through the virtual and real integrated game interface. The third choice information is generated by the raffle choosing interface 12 according to a raffle selecting choice made by the player through the raffle choosing interface 12.

In order to better demonstrate features, technical means, and expected results of the present invention, detail executions are included in the following.

With reference to FIGS. 1, 2, and 3, an execution of the intelligent interactive game system 100 is detailed. First the host 11 executes the choosing step S1. Through the initial interface 31 displayed by the display module 12, the host 11 generates the service information 21 according to first choice information of the initial interface 31. Then the host 11 executes the sending step S2. Through the communication module 15 connected to the host 11, the encryption information 22 and the electronic ticket information 23 are sent to the electronic ticket database 14, wherein the encryption information 22 includes a card serial number, a card holder's name, authorization, etc., and the electronic ticket information 23 includes trading records, corresponding balance, points record, etc. Then the host 11 executes the matching step S3, to confirm the encryption information 22 and the electronic ticket information 23 are identical to information stored in the electronic ticket database 14 through the host 11. Then the host 11 executes the displaying step S4. Through the display module 12, the electronic ticket information 23 and the virtual and real integrated interface 32 relating to the service information 21 are simultaneously displayed. Thus, the virtual and real integrated interface 32 allows the player to manipulate, and the virtual and real integrated interface 32 accordingly generates the first manipulation information.

As such, by bi-directionally verifying both the host 11 and the contactless electronic ticket 13 with the encryption information 22 and the electronic ticket information 23, the intelligent interactive game system 100 is both convenient and safe to be used.

The following figures detail a first embodiment of the intelligent interactive game system 100, so that people skilled in the art can understand the present invention better. Numbers in the following figures corresponds to what was described previously in FIGS. 1 and 2. Similar features and effects already described previously are omitted as to reduce redundancy.

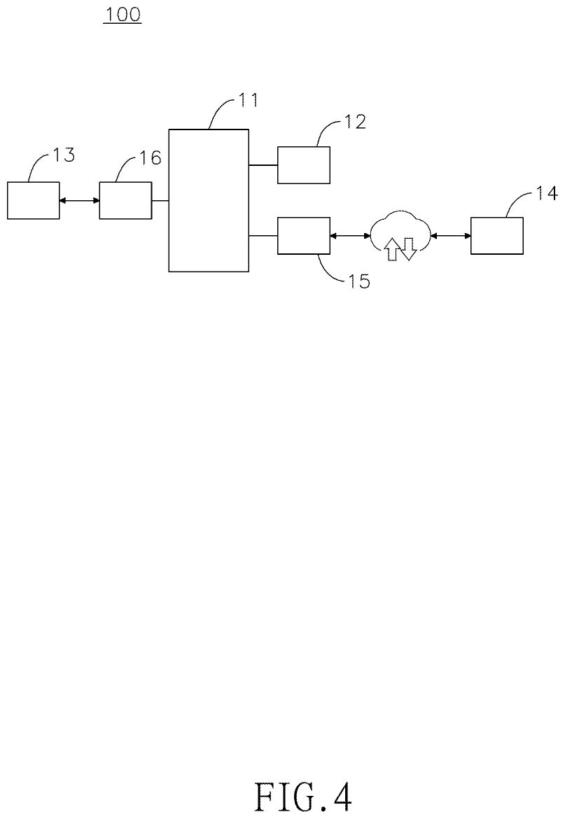

With reference to FIG. 1. FIG. 4 details a perspective view of the first embodiment of the intelligent interactive game system 100. Here the intelligent interactive game system 100 includes the host 11, the display module 12, the contactless electronic ticket 13, the electronic ticket database 14, the communication module 15, and the sensing module 16. The sensing module 16 is coupled to the host 11, and the sensing module is used to scan the encryption information 22 and the electronic ticket information 23 stored in the contactless electronic ticket 13.

In this embodiment, the contactless electronic ticket 13 may use the RFID method to create the encryption information 22. The RFID method uses wireless waves to track certain tags. Through the sensing module 16, these tags are scanned to identify contents stored in the contactless electronic ticket 13.

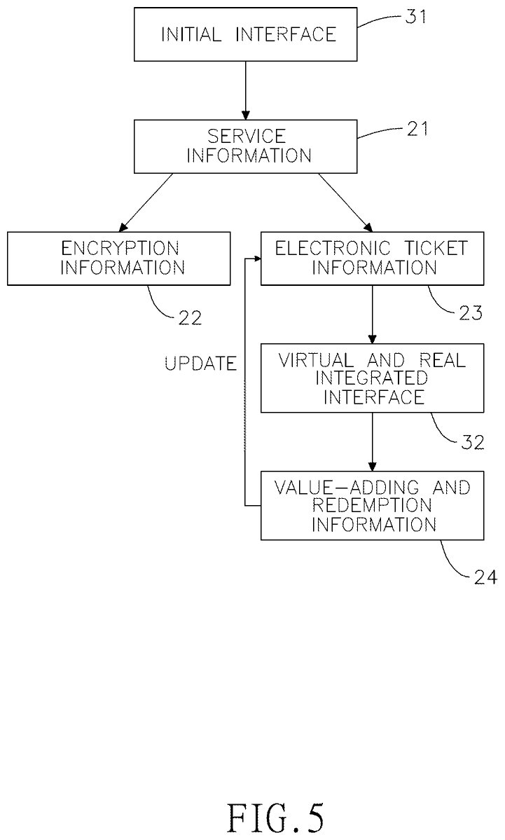

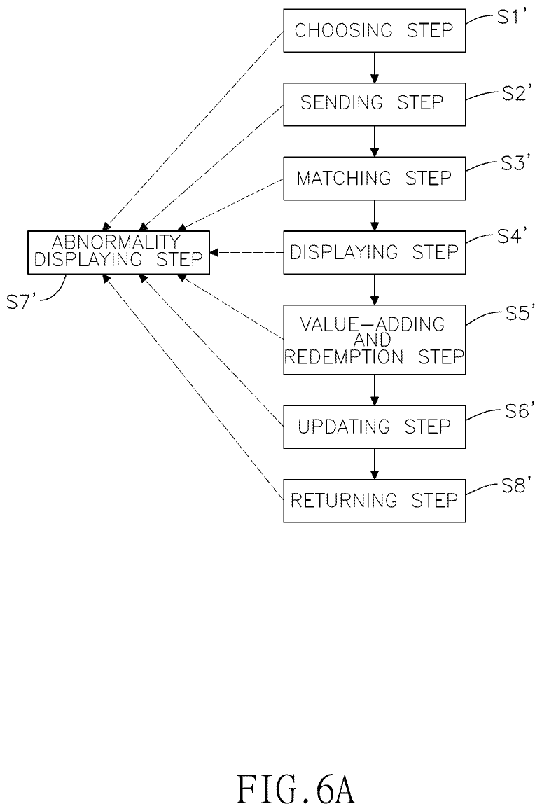

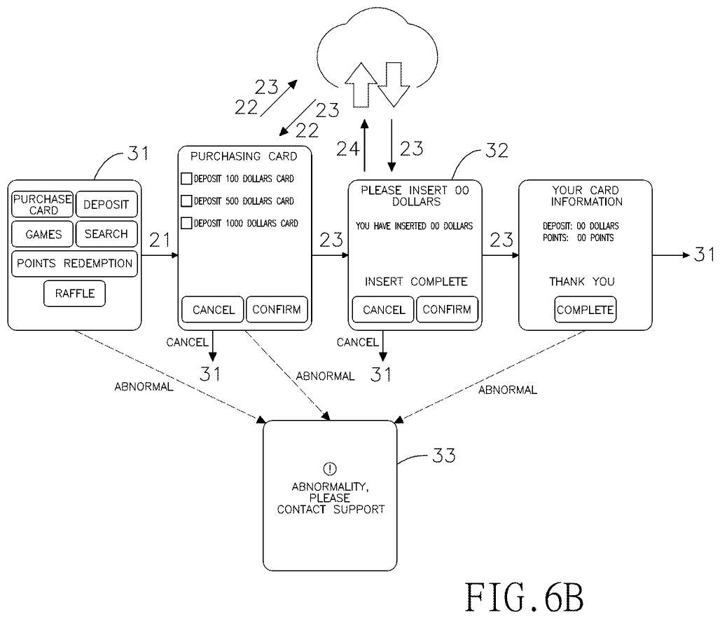

With reference to FIGS. 5 and 6A, FIG. 5 details flow chart for executing steps of the first embodiment of the value-adding and redemption method. The present invention uses the intelligent interactive game system 100 as a base to further provide the value-adding and redemption method for executing the first embodiment of the intelligent interactive game system 100. The value-adding and redemption method further includes the value-adding and redemption step S5′, wherein the host 11 generates the value-adding and redemption information 24 according to the first manipulation information of the virtual and real integrated interface 32 and sends the value-adding and redemption information 24 through the communication module 15 to the electronic ticket database 14. The value-adding and redemption method further includes the updating step S6′, wherein the electronic ticket database 14 updates the electronic ticket information 23 according to the value-adding and redemption information 24.

With reference to FIGS. 4. 5, and 6A, the host 11 first executes choosing step S1′ to display the initial interface 31 through the displaying module 12. The host 11 creates the service information 21 accordingly to the first choice information of the initial interface 31. The host 11 then executes the sending step S2′. Through the communication module 15 connected to the host 11, the encryption information 22 and the electronic ticket information 23 are sent to the electronic ticket database 14, wherein the encryption information 22 includes a card serial number, a card holder's name, authorization, etc., and the electronic ticket information 23 includes trading records, corresponding balance, points records, etc. Then the host 11 executes the matching step S3′, to confirm the encryption information 22 and the electronic ticket information 23 are identical to information stored in the electronic ticket database 14. Then the host 11 executes the displaying step S4′. Through the display module 12, the electronic ticket information 23 and the virtual and real integrated interface 32 relating to the service information 21 are simultaneously displayed. Thus, the virtual and real integrated interface 32 allows the player to manipulate, and the virtual and real integrated interface 32 accordingly generates the first manipulation information. Then the host 11 executes the value-adding and redemption step S5′, wherein the host 11 creates the value-adding and redemption information 24 according to the first manipulation information of the virtual and real integrated interface 32 and sends the value-adding and redemption information 24 from the communication module 15 to the electronic ticket database 14. The value-adding and redemption method further includes the updating step S6′, wherein the electronic ticket database 14 updates the electronic ticket information 23 according to the value-adding and redemption information 24.

With reference to FIG. 6A. When any of the steps is abnormal in the first embodiment, the host 11 further executes the abnormality displaying step S7′. For instance, when the corresponding balance is off, the contactless electronic ticket 13 is irresponsive, the trading record is unusual, then the intelligent interactive game system 100 will determine an abnormality has occurred, and correspondingly display an abnormal interface through the display module 12.

With respect to FIGS. 6A and 6B, the first embodiment further includes a returning step S8′, wherein the updated electronic ticket information 23 is returned to the host 11 through the electronic ticket database 14, and the updated electronic ticket information 23 is displayed through the display module 12.

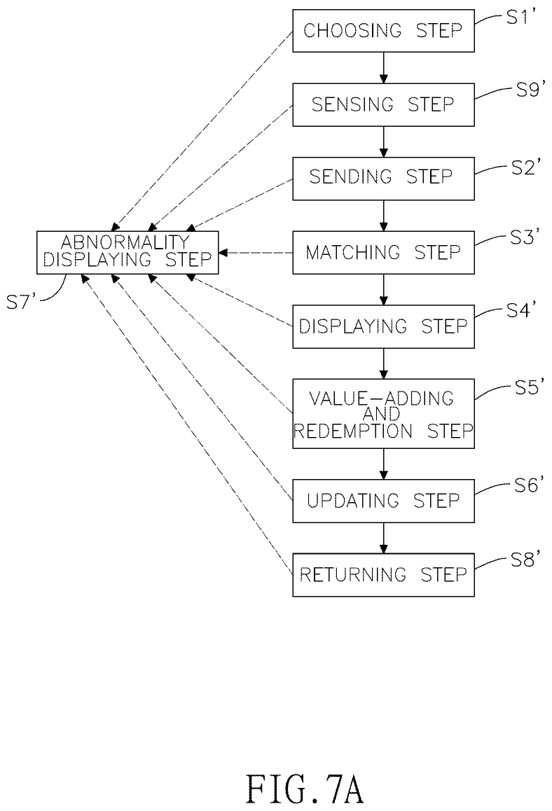

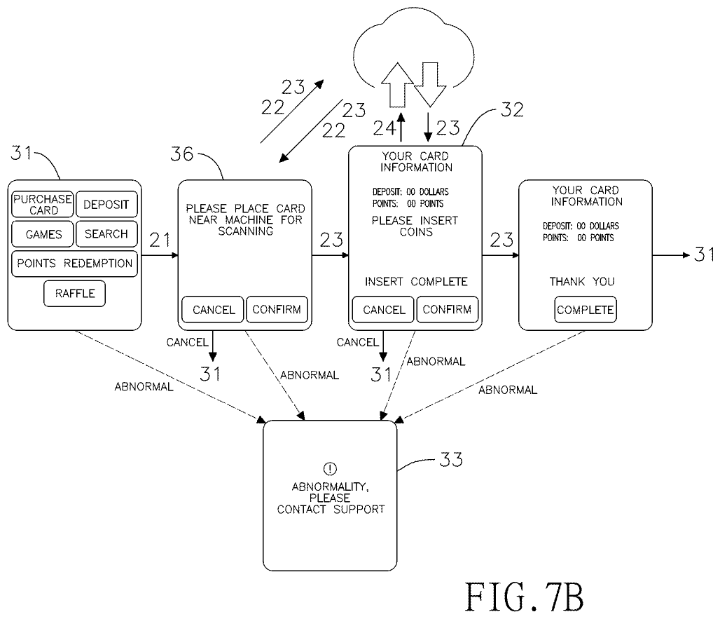

With respect to FIGS. 7A and 7B, the first embodiment further includes a sensing step S9′, wherein through a sensing module 16 connected to the host 11, the encryption information 22 and the electronic ticket information 23 stored in the contactless electronic ticket 13 are scanned, and the sensing interface 36 is displayed through the display module 12. Here the contactless electronic ticket 13 uses the RFID method to generate the encryption information 22.

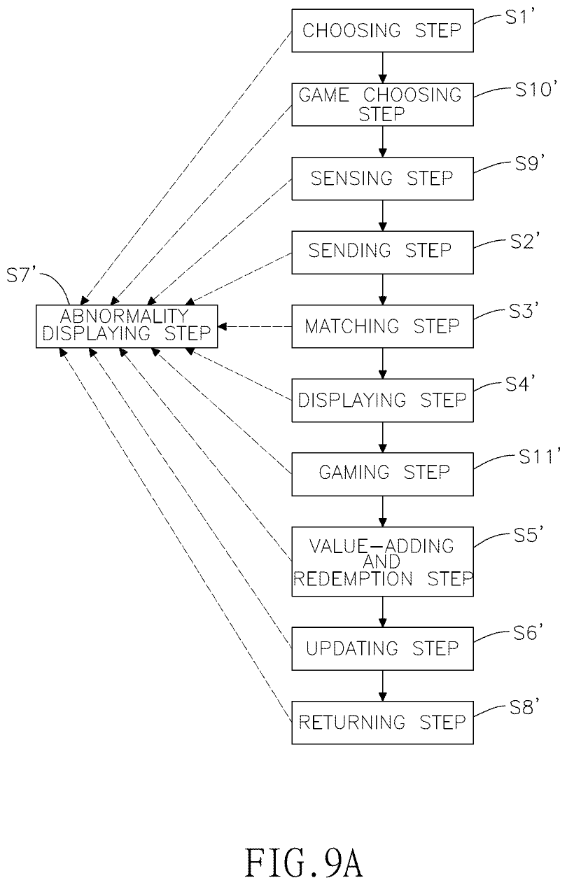

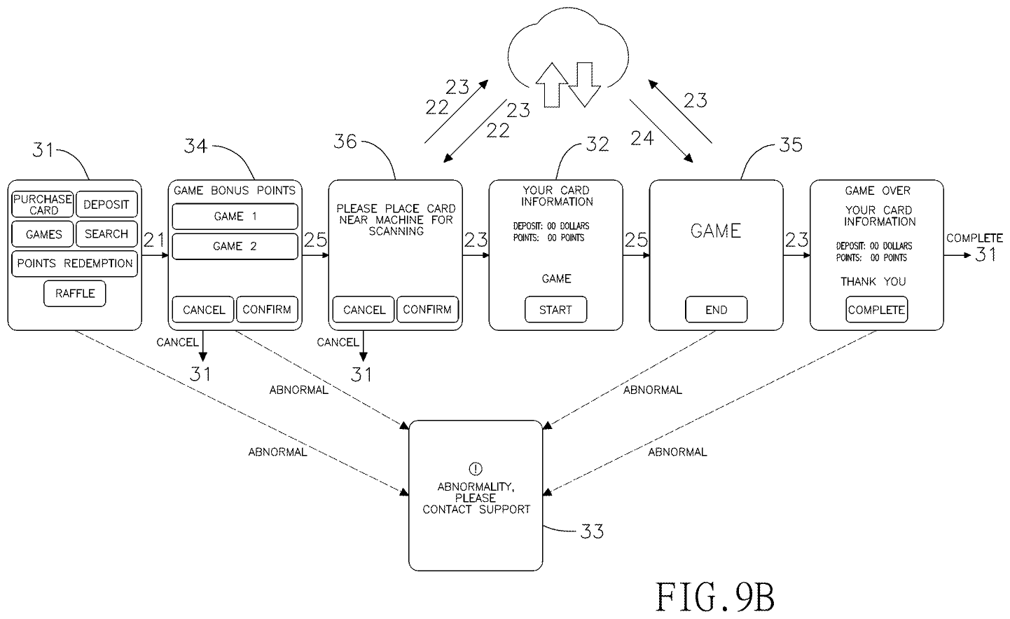

With respect to FIGS. 9A and 9B, the first embodiment further includes the game choosing step S10′. Through the display module 12, the game choosing interface 34 is displayed. The host 11 creates the game execution information 25 according to the second choice information of the game choosing interface 34. The first embodiment further includes the gaming step S11′, wherein through the display module 12, the virtual and real integrated game interface 35 relating to the game execution information 25 is displayed. The virtual and real integrated game interface 35 is provided for the player.

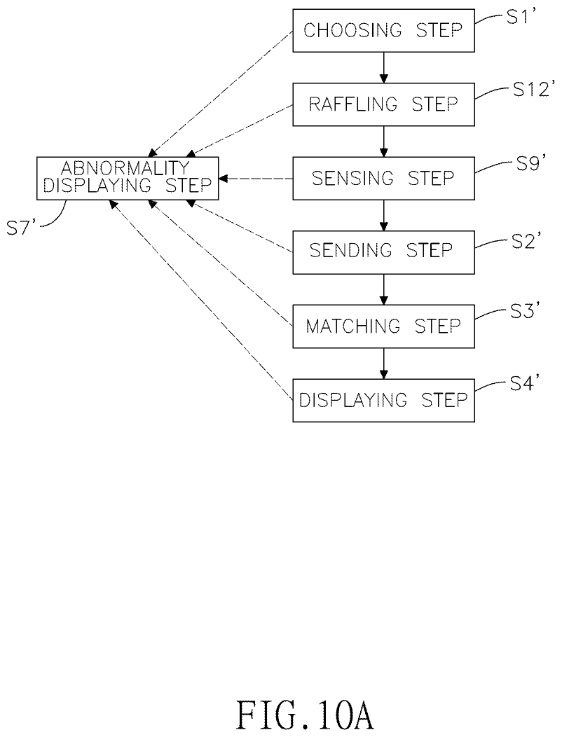

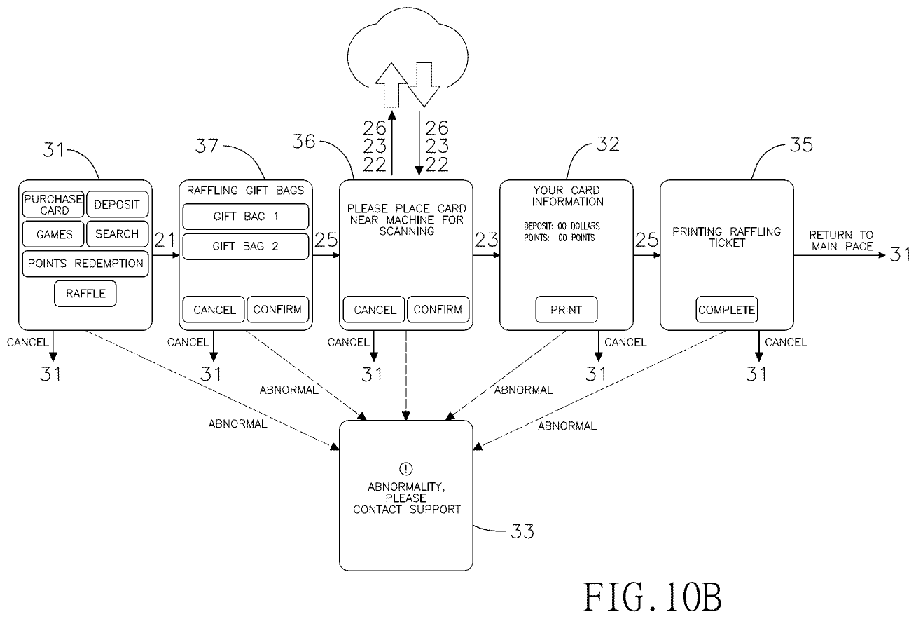

With respect to FIGS. 10A and 10B, the first embodiment further includes a raffling step S12′, wherein according to the third choice of the raffle choosing interface 37, the host 11 creates the raffling information 25.

With respect to FIGS. 4, 6A, and 6B, FIG. 6A details a block diagram for buying a card in the first embodiment of the value-adding and redemption method of the present invention, and FIG. 6B details a flow chart for buying a card in the first embodiment of the value-adding and redemption method of the present invention.

First the host 11 executes the choosing step S1′ to display the initial interface 31 through the display module 12. According to FIG. 6B, the initial interface 31 includes options such as to buy a card, to make a deposit, to play a game, to initiate a search, to redeem points, and to participate in raffling. Based on the player's choice through the initial interface 31, the host 11 correspondingly creates the service information 21. The host 11 then executes the sending step S2′. Through the communication module 15 connected to the host 11, the encryption information 22 and the electronic ticket information 23 are sent to the electronic ticket database 14, wherein the encryption information 22 includes a card serial number, a card holder's name, authorization, etc., and the electronic ticket information 23 includes trading records, corresponding balance, points records, etc. Then the host 11 executes the matching step S3′, to confirm the encryption information 22 and the electronic ticket information 23 are identical to the information stored in the electronic ticket database 14. Then the host 11 executes the displaying step S4′. Through the display module 12, the electronic ticket information 23 and the virtual and real integrated interface 32 relating to the service information 21 are simultaneously displayed. Then the host 11 executes the value-adding and redemption step S5′, wherein the host 11 creates the value-adding and redemption information 24 according to the first manipulation information of the virtual and real integrated interface 32 and sends the value-adding and redemption information 24 from the communication module 15 to the electronic ticket database 14. The host 11 further executes the updating step S6′, wherein the electronic ticket database 14 updates the electronic ticket information 23 according to the value-adding and redemption information 24.

With respect to FIGS. 6A and 613, when any of the abnormalities occur during a search, the host 11 executes the abnormality displaying step S7′. When the intelligent interactive game system 100 determines that an abnormality has occurred, the abnormal interface is displayed through the display module 12.

With respect to FIGS. 4, 7A, and 7B, FIG. 7A details a block diagram for value-adding in the first embodiment of the value-adding and redemption method of the present invention, and FIG. 7B details a flow chart for value-adding in the first embodiment of the value-adding and redemption method of the present invention.

First the host 11 executes the choosing step S1′ to display the initial interface 31 through the display module 12. According to FIG. 7B, the initial interface 31 includes options such as to buy a card, to make a deposit, to play a game, to initiate a search, to redeem points, and to participate in raffling. Based on the player's choice through the initial interface 31, the host 11 correspondingly creates the service information 21. The host 11 then executes the sensing step S9′, wherein through the sensing module 16 connected to the host 11, the encryption information 22 and the electronic ticket information 23 stored in the contactless electronic ticket 13 are scanned, and the sensing interface 36 is displayed through the display module 12. The host 11 then executes the sending step S2′. Through the communication module 15 connected to the host 11, the encryption information 22 and the electronic ticket information 23 are sent to the electronic ticket database 14, wherein the encryption information 22 includes a card serial number, a card holder's name, authorization, etc., and the electronic ticket information 23 includes trading records, corresponding balance, points records, etc. Then the host 11 executes the matching step S3′, to confirm the encryption information 22 and the electronic ticket information 23 are identical to information stored in the electronic ticket database 14. Then the host 11 executes the displaying step S4′. Through the display module 12, the electronic ticket information 23 and the virtual and real integrated interface 32 relating to the service information 21 are simultaneously displayed. With reference to FIG. 7B, the virtual and real integrated interface 32 allows interactions with the player. Then the host 11 executes the value-adding and redemption step S5′, wherein the host 11 creates the value-adding and redemption information 24 according to the first manipulation information of the virtual and real integrated interface 32 and sends the value-adding and redemption information 24 from the communication module 15 to the electronic ticket database 14. The host 11 further executes the updating step S6′, wherein the electronic ticket database 14 updates the electronic ticket information 23 according to the value-adding and redemption information 24. Finally, the host 11 executes the returning step S8′, wherein the updated electronic ticket information 23 is returned to the host 11 through the electronic ticket database 14, and, as shown in FIG. 7B, the updated electronic ticket information 23 is displayed through the display module 12.

With respect to FIGS. 7A and 7B, when any of the abnormalities occur during a search, the host 11 executes the abnormality displaying step S7′. When the intelligent interactive game system 100 determines that an abnormality has occurred, such as when the corresponding balance is off, the contactless electronic ticket 13 is irresponsive, or the trading record is unusual, the abnormal interface 33 is displayed through the display module 12.

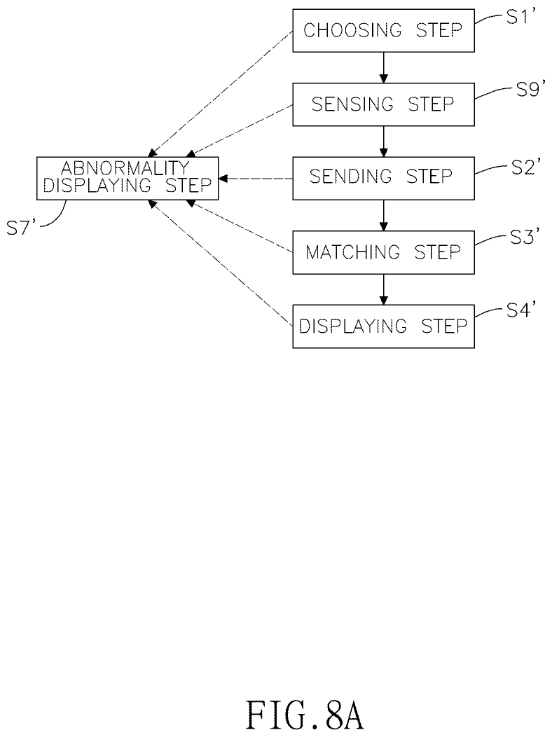

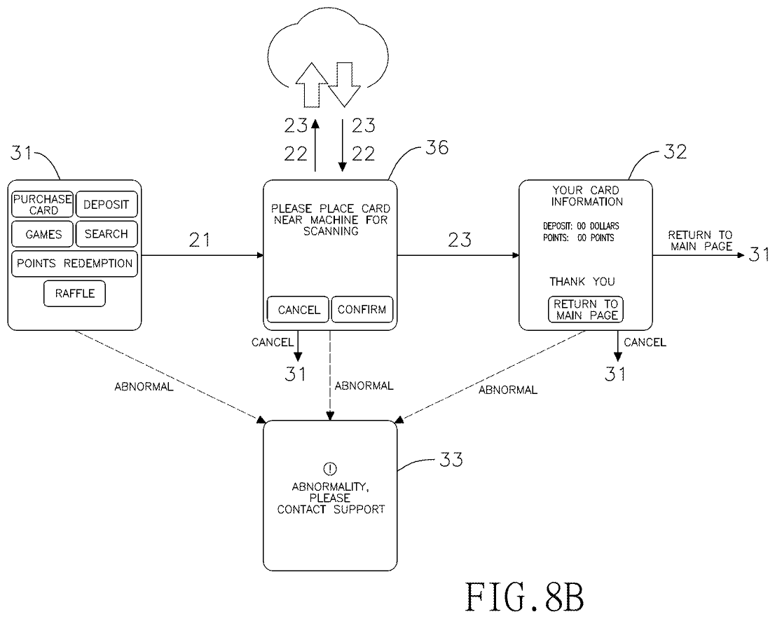

With respect to FIGS. 4A, 8A, and 8B, FIG. 8A details a block diagram for executing search in the first embodiment of the value-adding and redemption method of the present invention, and FIG. 8B details a flow chart for executing search in the first embodiment of the value-adding and redemption method of the present invention.

First the host 11 executes the choosing step S1′ to display the initial interface 31 through the display module 12. According to FIG. 8B the initial interface 31 includes options such as to buy a card, to make a deposit, to play a game, to initiate a search, to redeem points, and to participate in raffling. Based on the player's choice through the initial interface 31, the host 11 correspondingly creates the service information 21. The host 11 then executes the sensing step S9′, wherein through the sensing module 16 connected to the host 11, the encryption information 22 and the electronic ticket information 23 stored in the contactless electronic ticket 13 are scanned, and the sensing interface 36 is displayed through the display module 12. The host 11 then executes the sending step S2′. Through the communication module 15 connected to the host 11, the encryption information 22 and the electronic ticket information 23 are sent to the electronic ticket database 14, wherein the encryption information 22 includes a card serial number, a card holder's name, authorization, etc., and the electronic ticket information 23 includes trading records, corresponding balance, points records, etc. Then the host 11 executes the matching step S3′, to confirm the encryption information 22 and the electronic ticket information 23 are identical to information stored in the electronic ticket database 14. Then the host 11 executes the displaying step S4′. Through the display module 12, the electronic ticket information 23 and the virtual and real integrated interface 32 relating to the service information 21 are simultaneously displayed. With reference to FIG. 8B, the virtual and real integrated interface 32 allows interactions with the player.

With respect to FIGS. 8A and 8B, when any of the abnormalities occurs during a search, the host 11 executes the abnormality displaying step S7′. When the intelligent interactive game system 100 determines that an abnormality has occurred, such as when the corresponding balance is off, the contactless electronic ticket 13 is irresponsive, or the trading record is unusual, the abnormal interface 33 is displayed through the display module 12.

With respect to FIGS. 4, 9A, and 9B, FIG. 9A details a block diagram for running games in the first embodiment of the value-adding and redemption method of the present invention, and FIG. 9B details a flow chart for running games in the first embodiment of the value-adding and redemption method of the present invention.

First the host 11 executes the choosing step S1′ to display the initial interface 31 through the display module 12. According to FIG. 9B, the initial interface 31 includes options such as to buy a card, to make a deposit, to play a game, to initiate a search, to redeem points, and to participate in raffling. Based on the player's choice through the initial interface 31, the host 11 correspondingly creates the service information 21. The host 11 then executes the sensing step S10′. Through the display module 12, the game choosing inter-face 34 is displayed. The host 11 creates the game execution information 25 according to the choice made by the player through the game choosing interface 34. The host 11 then executes the sensing step S9′, wherein through the sensing module 16 connected to the host 11, the encryption information 22 and the electronic ticket information 23 stored in the contactless electronic ticket 13 are scanned, and the sensing interface 36 is displayed through the display module 12. The host 11 then executes the sending step S2′. Through the communication module 15 connected to the host 11, the encryption information 22 and the electronic ticket information 23 are sent to the electronic ticket database 14, wherein the encryption information 22 includes a card serial number, a card holder's name, authorization, etc., and the electronic ticket information 23 includes trading records, corresponding balance, points records, etc. Then the host 11 executes the matching step S3′, to confirm the encryption information 22 and the electronic ticket information 23 are identical to information stored in the electronic ticket database 14. Then the host 11 executes the displaying step S4′. Through the display module 12, the electronic ticket information 23 and the virtual and real integrated interface 32 relating to the service information 21 are simultaneously displayed. With reference to FIG. 9B, the virtual and real integrated interface 32 allows interactions with the player. Then the host 11 executes the displaying step S11′, wherein through the display module 12, the virtual and real integrated game interface 35 relating to the game execution information 25 is displayed. Furthermore, the virtual and real integrated game interface 35 is provided to interact with the player. Then the host 11 executes the value-adding and redemption step S5′, wherein the host 11 creates the value-adding and redemption information 24 according to player manipulation of the virtual and real integrated interface 32 and sends the value-adding and redemption information 24 to the electronic ticket database 14 through the communication module 15. The host 11 further executes the updating step S6′, wherein the electronic ticket database 14 updates the electronic ticket information 23 according to the value-adding and redemption information 24. Finally, the host 11 executes the returning step S8′, wherein the updated electronic ticket information 23 is returned to the host 11 through the electronic ticket database 14, and, as shown in FIG. 9B, the updated electronic ticket information 23 is displayed through the display module 12.

With respect to FIGS. 9A and 9B, when any of the abnormalities occurs during a search, the host 11 executes the abnormality displaying step S7′. When the intelligent interactive game system 100 determines that an abnormality has occurred, such as when the corresponding balance is off, the contactless electronic ticket 13 is irresponsive, or the trading record is unusual, the abnormal interface 33 is displayed through the display module 12.

Based on the above descriptions, the intelligent interactive game system 100, while available for value-adding, the player can also play games to deposit values. As a result, the present invention provides an automatic value-adding interactive game system, wherein values are added automatically as games are being played. The present invention is both entertaining for the player and compatible for various game machines.

With respect to FIGS. 4, 10A, and 1013, FIG. 10A details a block diagram for raffling in the first embodiment of the value-adding and redemption method of the present invention, and FIG. 10B details a flow chart for raffling in the first embodiment of the value-adding and redemption method of the present invention.

First the host 11 executes the choosing step S1′ to display the initial interface 31 through the display module 12. According to FIG. 10B, the initial interface 31 includes options such as to buy a card, to make a deposit, to play a game, to initiate search, to redeem points, and to participate in raffling. According to the first choice of the initial interface 31, the host 11 correspondingly creates the service information 21. The host 11 then executes the raffling step S12′, wherein according to the third choice information of the raffle choosing interface 37, the host 11 creates a raffling information 25. The host 11 then executes the sensing step S9′, wherein through the sensing module 16 connected to the host 11, the encryption information 22 and the electronic ticket information 23 stored in the contactless electronic ticket 13 are scanned, and the sensing interface 36 is displayed through the display module 12. The host 11 then executes the sending step S2′. Through the communication module 15 connected to the host 11, the encryption information 22 and the electronic ticket information 23 are sent to the electronic ticket database 14, wherein the encryption information 22 includes a card serial number, a card holder's name, authorization, etc., and the electronic ticket information 23 includes trading records, corresponding balance, points records, etc. Then the host 11 executes the matching step S3′, to confirm the encryption information 22 and the electronic ticket information 23 are identical to the information stored in the electronic ticket database 14. Then the host 11 executes the displaying step S4′. Through the display module 12, the electronic ticket information 23 and the virtual and real integrated interface 32 relating to the service information 21 are simultaneously displayed.

With respect to FIGS. 10A and 10B, when an of the abnormalities occurs during a search, the host 11 executes the abnormality displaying step S7′. When the intelligent interactive game system 100 determines that an abnormality has occurred, such as when the corresponding balance is off, the contactless electronic ticket 13 is irresponsive, or the trading record is unusual, the abnormal interface 33 is displayed through the display module 12.

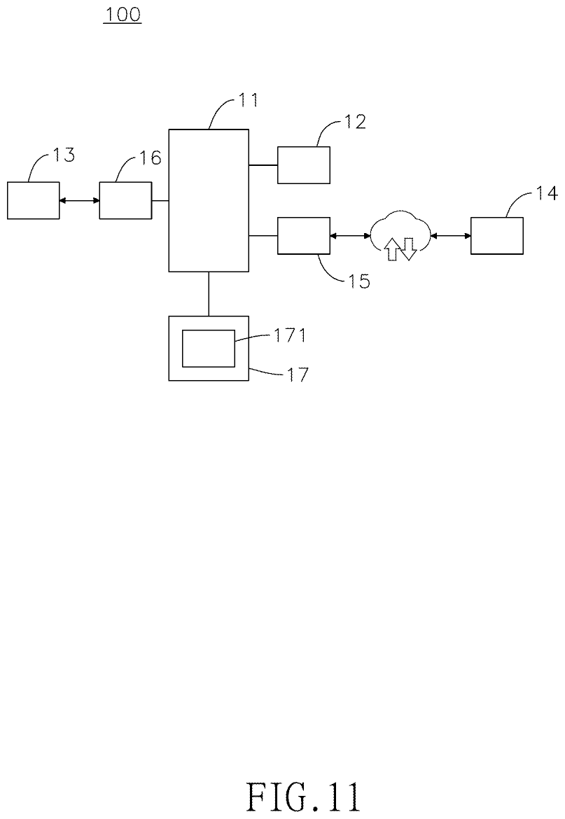

With respect to FIG. 11, FIG. 11 details a perspective view of a second embodiment of the intelligent interactive game system of the present invention. In the second embodiment of the intelligent interactive game system, the intelligent interactive game system 100 includes the host 11, the display module 12, the contactless electronic ticket 13, the electronic ticket database 14, the communication module 15, the sensing module, and the redemption counter 17.

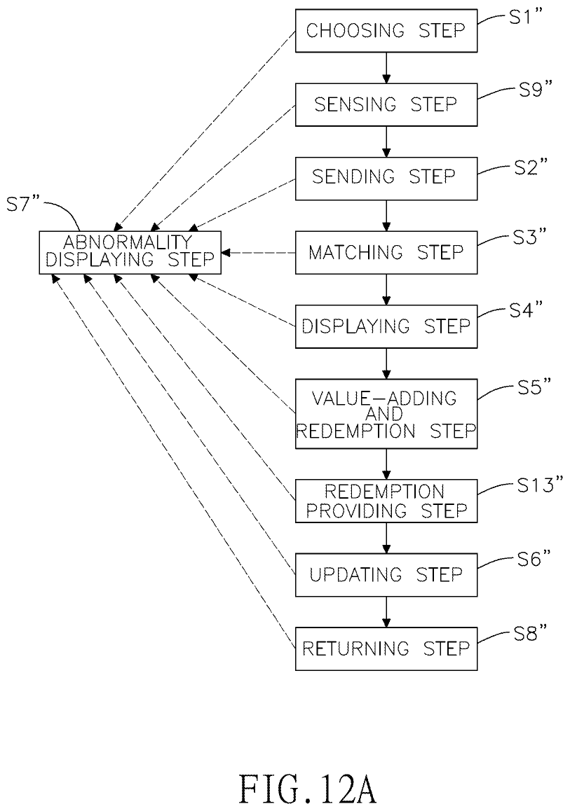

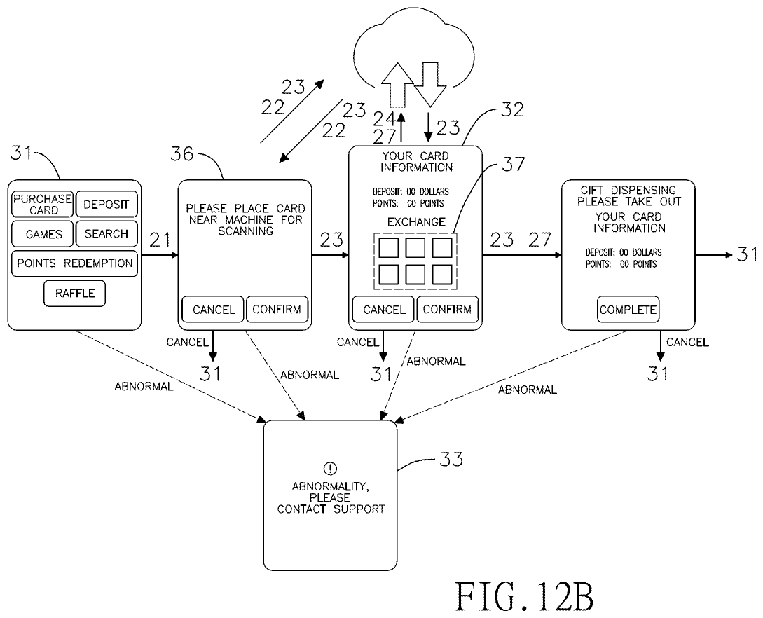

With respect to FIGS. 11, 12A, and 12B, the redemption counter 17 is coupled to the host 11, and the redemption counter 17 includes multiple redemption items 171. Each of the redemption items 171 includes a corresponding redemption choosing information 27. For example, the redemption counter 17 can be one or more display shelves, each display shelf includes automated door opener and a display area. The automated door opener is coupled to the host 11, and the display area is used to store the redemption items 171. The host 11 is able to open the automated door opener correspondingly to the redemption choosing information 27, for giving the player the corresponding redemption items 171.

With respect to FIGS. 11, 12A, and 12B, FIG. 12A details a block diagram for executing redemption in the second embodiment of the value-adding and redemption method of the present invention, and FIG. 12B details a flow chart for executing redemption in the second embodiment of the value-adding and redemption method of the present invention.

First the host 11 executes the choosing step S1″ to display the initial. interface 31 through the display module 12. According to FIG. 12B, the initial interface 31 includes options such as to buy a card, to make a deposit, to play a game, to initiate a search, to redeem points, and to participate in raffling. Based on the player's choice through the initial interface 31, the host 11 correspondingly creates the service information 21. The host 11 then executes the sensing step S9″, wherein through the sensing module 16 connected to the host 11, the encryption information 22 and the electronic ticket information 23 stored in the contactless electronic ticket 13 are scanned, and the sensing interface 36 is displayed through the display module 12. The host 11 then executes the sending step S2″. Through the communication module 15 connected to the host 11, the encryption information 22 and the electronic ticket information 23 are sent to the electronic ticket database 14, wherein the encryption information 22 includes a card serial number, a card holder's name, authorization, etc., and the electronic ticket information 23 includes trading records, corresponding balance, points records, etc. Then the host 11 executes the matching step to confirm the encryption information 22 and the electronic ticket information 23 are identical to information stored in the electronic ticket database 14. Then the host 11 executes the displaying step S4″. Through the display module 12, the electronic ticket information 23 and the virtual and real integrated interface 32 relating to the service information 21 are simultaneously displayed. With reference to FIG. 12B, the virtual and real integrated interface 32 allows interactions with the player. The virtual and real integrated interface 32 includes the raffle choosing interface 37, and according to the first manipulation information of the virtual and real integrated interface 32, the host 11 creates the redemption choosing information 27. Then the host 11 executes the value-adding and redemption step S5″, wherein the host 11 creates the value-adding and redemption information 24 according to the first manipulation information of the virtual and real integrated interface 32 and sends the value-adding and redemption information 24 to the electronic ticket database 14 through the communication module 15. Then the host 11 executes the redemption providing step S13″, wherein the host 11 controls the redemption counter 17 according to the redemption choosing information 27, and the redemption counter 17 correspondingly dispenses the redemption items 171 according to the redemption choosing information 27. The host 11 further executes the updating step S6″, wherein the electronic ticket database 14 updates the electronic ticket information 23 according to the value-adding and redemption information 24. Finally, the host 11 executes the returning step S8″, wherein the updated electronic ticket information 23 is returned to the host 11 through the electronic ticket database 14, and, as shown in FIG. 12B, the updated electronic ticket information 23 is displayed through the display module 12.

With respect to FIGS. 12A and 12B, when any of the abnormalities occurs during a search, the host 11 executes the abnormality displaying step S7″. When the intelligent interactive game system 100 determines that an abnormality has occurred, such as when the corresponding balance is off, the contactless electronic ticket 13 is irresponsive, or the trading record is unusual, the abnormal interface 33 is displayed through the display module 12.

Based on the above descriptions, a person skilled in the related field should be able to make changes and adjustments relating to the present invention. For this reason, giving further examples would be considered redundant. The above embodiments serve as examples rather than limitations for the present invention. In other words, the present invention is free to be elsewise relating to the present invention in other embodiments of the present invention.

To conclude, the present invention gathers the following advantages:

First, based on the intelligent interactive game system 100, the electronic ticket information 23 and the encryption information 22 are able to bi-directionally verify the contactless electronic ticket 13 and the host 11. This ensures safety for the intelligent interactive game system 100 of the present invention.

Second, through having the contactless electronic ticket 13 and the electronic ticket database 14 simultaneously storing the encryption information 22 and the electronic ticket information 23, according to the first manipulation information of the virtual and real integrated interface 32, the host 11 can increase or decrease points or values in games accordingly for the points information

Third, through the display module 12, the host 11 is able to display the virtual and real integrated game interface 32 for the player to manipulate. According to the player manipulation through the virtual and real integrated game interface 32, value-adding prizes can be earned. The value-adding prizes can be used on game machines already existing in the arcade room. For this reason, the intelligent interactive game system 100 is compatible for various game machines and highly entertaining for the player.

Fourth, the host 11 controls the redemption counter 17 based on the redemption choosing information 27. The redemption counter 17 is able to dispense the redemption items 171 automatically based on the corresponding redemption choosing information 27. For this reason, the intelligent interactive came system 100 can be effectively installed in arcades without maintainers. The present invention helps to reduce manpower needed to maintain game systems.

What is claimed is:

1. A value-adding and redemption method, adapted to an intelligent interactive game system; wherein the interactive game system comprises a host and a display module, and the value-adding and redemption method comprises:
a choosing step: displaying an initial interface through the display module, and generating service information according to first choice information of the initial interface through the host;
a sending step: sending encryption information and electronic ticket information to an electronic ticket database through a communication module connected to the host; wherein the encryption information and the electronic ticket information are related to a contactless electronic ticket;
a matching step: confirming whether the encryption information and the electronic ticket information are identical to information stored in the electronic ticket database through the electronic ticket database;
a displaying step: displaying the electronic ticket information and a virtual and real integrated interface relating to the service information simultaneously through the display module.

2. The value-adding and redemption method as claimed in claim 1, further comprising:
a value-adding and redemption step: generating value-adding and redemption information according to first manipulation information of the virtual and real integrated interface through the host, and sending the value-adding and redemption information to the electronic ticket database through the communication module; and
an updating step: updating the electronic ticket information according to the value-adding and redemption information through the electronic ticket database.

3. The value-adding and redemption method as claimed in claim 1, further comprising:
a returning step: returning the updated electronic ticket information to the host through the electronic ticket database, and displaying the updated electronic ticket information through the display module; and
a sensing step: sensing the encryption information and the electronic ticket information stored in the contactless electronic ticket through a sensing module connected to the host, and displaying a sensing interface through the display module;
wherein, the contactless electronic ticket uses a radio-frequency identification (RFID) method to generate the encryption information.

4. The value-adding and redemption method as claimed in claim 1, further comprising:
an abnormality displaying step: displaying an abnormal interface through the display module when any one of the steps of the value-adding and redemption method shows abnormalities.

5. The value-adding and redemption method as claimed in claim 2, further comprising:
a game choosing step: displaying a game choosing interface through the display module, and creating game execution information according to second choice information of the game choosing interface through the host; and
a gaming step: displaying a virtual and real integrated game interface relating to the game execution information through the display module;
wherein, for the value-adding and redemption step, the value adding and redemption information is further generated according to the first manipulation information of the virtual and real integrated interface and second manipulation information of the virtual and real integrated game interface through the host.

6. The value adding and redemption method as claimed it claim 1, further comprising:
a raffling step: generating raffle information according to third choose information of a raffle choosing interface through the host; wherein for the sending step, the raffle information is further sent to the electronic ticket database through the communication module.

7. The value-adding and redemption method as claimed in claim 1, further comprising:
an redemption providing step: controlling a redemption counter according to redemption choosing information through the host; wherein the redemption counter further provides a redemption item corresponding to the redemption choosing information; and wherein the virtual and real integrated interface further comprises a redemption choosing window, and the redemption choosing information is generated according to the first manipulation information of the virtual and real integrated interface through the host.

8. An intelligent interactive game system, comprising:
a host;
a display module, coupled to the host; wherein the display module displays an initial interface, and the host creates service information according to the initial interface;
a contactless electronic ticket, connected to the host; wherein the contactless electronic ticket stores encryption information and electronic ticket information; and wherein the encryption information and the electronic ticket information are related to the contactless electronic ticket;
electronic ticket database, installed in a cloud server to connect to the host; wherein the electronic ticket database also stores the encryption information and the electronic ticket information;
a communication module, coupled to the host, allowing real-time bi-directional data transfers between the host and the electronic ticket database;
wherein when first choice information is generated through the initial interface, the display module further displays a virtual and real integrated interface related to the service information; and
wherein the virtual and real integrated interface generates first manipulation information.

9. The intelligent interactive game system as claimed in claim 8, further comprising:
a sensing module, coupled to the host, sensing the encryption information and the electronic ticket information stored in the contactless electronic ticket;
wherein the contactless electronic ticket uses a radio-frequency identification (RFID) method to generate the encryption information.

10. The intelligent interactive game system as claimed in claim 8, further comprising:
a redemption counter, coupled to the host; wherein the redemption counter includes multiple redemption items, and each of the redemption items corresponds to at least one piece of redemption choosing information.
